(19) United States
(12) Patent Application Publication
(10) Pub. No.: US 2003/0184583 A1
(43) Pub. Date: Oct. 2, 2003

(54) Web os and web desktop

(76) Inventor: Chaeuk Lim, Seongnam-shi (KR)

Correspondence Address: Shinjyu Global IP Counselors, Suite 700, 1233 Twentieth Street NW, Washington, DC, 20036, US

(21) Appl. No.: 10/363,052

(22) PCT Filed: Jul. 27, 2001
(86) PCT No.: PCT/KR01/01284

(30) Foreign Application Priority Data
Jun. 28, 2001 (KR) 2001-37777

(51) Int. Cl. G09G 5/00

(52) U.S. Cl. 345/738

(57) ABSTRACT

Web based operating system (WebOS) that provides user interface which is applicable to any types of platform is provided. According to the invention, user interface which is generated by WebOS, Web Desktop, Device, System, and Program are provided. The device followed by this invention ‘providing web based user interface’ includes: fixed size of body folder; menu bar which located at a specific location on the body folder for locating links in order to execute programs; sub-objects formed on the body folder; icon which is formed on the body folder for locating links for executing programs and connecting to URLs; and body frame which communicates with the body folder, menu bar, sub-object, and icon.

### TECHNICAL FIELD

The present invention relates to operating system using network, more specifically Web Operating System and user interface provided by this Web operating system, or method, apparatus, system, and program for Web desktop.

### BACKGROUND OF THE INVENTION

As internet technology advances, user can access information more easily through the internet. Also, user can execute various application programs which is difficult to be executed on the local computer on the internet.

Hardware platform of User's computer system diversify and multiple operating systems are set on single platform as technology of computer hardware system advances. For hardware platform, there are IBM PC compatible platform, Sun platform and Macintosh platform etc. Also, window system, Dos, OS/2, UNIX etc. are operated on each hardware platform.

But, compatibility cooperation between this various hardware system and operation system can not be accomplished easily. Therefore, programmer has to develop versions of each application programs for specific Operation System and hardware system, which is called porting in general.

Therefore, user of the operating system for which the programmer has not provided porting can not use the application program on the operating system.

For standard to support all of hardware system and operation system, the WWW based on HTML is used currently.

Also, JAVA has been developed to use the resource on web through web browser under no matter what kind of hardware system and operation system. Though using the WWW or JAVA, Many users have to install the application program that they want, and store medium data in local computer.

Therefore, users have to purchase application program to install as well as the local computer on which application program is to be installed.

Also, current application programs trend to require the higher level's performance of local computer and larger hard disk space to meet the condition for application program. However, it is difficult to improve local computer's performance up to meet these conditions.

To solve this problem, platforms such as Network Computer and Thin Client have been developed.

These Network Computer and Thin client have comparatively low performance processor and smaller storage. Also, Network Computer and Thin client execute application program which the server provides through internet, and store the medium data in the server's storage.

These systems, such as Network Computer and Thin Client which connect to server and then operate the server's application program have been developed in recent year.

However, the most systems currently developed are designed to base on JAVA and to be operated on LAN. Therefore, compatibility problem of platform including conventional local computer have not solved yet.

### SUMMARY OF THE INVENTION

An object of the present invention is to provide Operating System based on WWW which support all kind of platform including conventional local computer, Network Computer and Thin client.

Another object of the present invention is to provide interface environment which is managed by system support all platforms based on WWW.

Another object of the present invention is to provide reliable transmission control method of controlling transmission of action or event that user create to server while maintaining user interface on Web.

In order to achieve these objects, an apparatus is provided to provide user interface based on WWW on internet according to the present invention. The Apparatus for providing interface based on Web according to present invention comprise a main body folder mean of fixed size, menu bar means displayed at predetermined position in the main body folder, at which program execution link is located, lower object means created on the main body folder, icon means created on the object body folder, at which program execution link and URL link located, and main body frame communicating with the main body folder means, menu bar means, lower object means and the icon means.

According to the present invention, an apparatus for supporting architecture which define user interface based on Web in the internet is provided.

The apparatus for supporting architecture defining user interface based on Web in the internet comprising, means for managing the cell layer(2401) defining cell to transfer data of the components comprising user interface on Web, mean for managing web desktop protocol(WDP) layer(2403) including distributed data access service(DDAS) layer(2507) processing distributed data access and web desktop service(WDS) layer(2405) processing cell traffic, and mean for managing client server protocol layer(2409).

According to the present invention, a method for controlling transmission on network with which server and client connected is provided. The method for controlling transmission comprise, creating data unit cells having predetermined number per action from data for processing. action occurred in the client judging whether the data cell is critical or not critical, storing the non critical cell to buffer in case of not being critical, creating data unit by combing the cell judged as non critical cell and the non critical cell stored in buffer, and transmitting the created data unit into the server.

### BRIEF DESCRIPTION OF THE DRAWINGS

FIG. 1 illustrates whole communication environment for providing operating system using network according to the present invention.

FIG. 2 illustrates client (101) constitute executing operating system, or Web OS using network according to the present invention.

FIG. 3 illustrates one embodiment of network architecture of Web OS according to the present invention.

FIG. 4 illustrates schematically preferred embodiment of network architecture managing web desktop interface.

FIG. 5 to FIG. 10 are block diagrams of server's components of Web OS architecture according to the present invention, which are embodied according to the number of user accommodated.

FIG. 11 is a block diagram illustrating the service architecture of Web OS according to the present invention.

FIG. 13 illustrates schematically Web desktop interface according to one embodiment of the present invention.

FIG. 14 illustrates schematically the Web desktop interface constitute according to the present invention.

FIG. 15 illustrates screen on which Web desktop interface embodied according to the present invention.

FIG. 16 illustrates schematically object and procedure for emboding Web desktop according to the present invention.

FIG. 17 illustrates schematically communication between procedure and each object and Web desktop interface according to the present invention.

FIG. 18 illustrates the hierarchy of Web desktop interface according to the present invention.

FIG. 19 illustrates schematically one example in which menu bars is displayed on Web desktop interface showed.

FIG. 20 arrange icon information, usage, common contribute and characteristic contributed, arranged by the type of icon formed at Web desktop interface respectively.

FIG. 21 is a table which show each scriptlet source, constitute, description and relevant application for folder object, A type application window object (1403), and G and O type application among lower object (1309) of Web desktop interface.

FIG. 22 illustrates the structure of data unit's cell, and structure of data that server module transmit to server (107) in physical.

FIG. 23 illustrates a example of transmitted data unit transmitted and created cell while sub module create cells and transmit it to server (107).

FIG. 24 illustrates a block diagram of service architecture of Web OS according to the present invention.

FIG. 25 is a table that shows the criterion for classifying data unit as critical or not critical cell, and examples of each cell.

FIG. 26 is block diagram showing the procedure of transport control through WDP protocol.

FIG. 27 illustrates the procedure of creating data unit by combining the critical cell and non critical cell.

FIG. 28 illustrates subroutine call procedure that is relevant to menu bar when Web desktop interface loads on client according to the present invention.

FIG. 29 illustrates subroutine call procedure that is relevant to the menu bar occurring when action that pointer moves occurs.

FIG. 30 illustrates subroutine call procedure that is relevant to main body when Web desktop interface loads on a client.

FIG. 31 illustrates subroutine call procedure that is relevant to the main body when predetermined action occurs on Web desktop interface.

<Description of the symbols of the important part of the drawings>

| | |
|---|---|
| 1301: main body frame | 1303: main body folder |
| 1305: top menu | 1307: bottom menu |
| 1309: lower object | 1311: icon |
| 1401: folder object | 1403: A type application window |

1405: G and O type application window

### DETAILED DESCRIPTION

1. Terms and Abbreviations

The following is explanation of words and abbreviations.

Internet:

Internet is defined as an assembly of connected network that form global distributed network to be connected by standard protocol (such as TCP/IP and HTTP).lnternet should be interpreted to cover possible modification in the future including change or adding can be done to the present standard protocol.

World Wide Web, WWW (or “Web”):

WWW is called both a distributed assembly of hypertext document that is accessible through internet, and components of server and client software providing access for user to the above stated hypertext using standard internet protocol. At present, main standard protocol by which application relocate and acquire Web document is HTTP, Web page is encoded by HTML. However, Web and World Wide Web should be interpreted to include make up and transfer protocol in future.

Client-Server:

Client-Server means cooperating model in distributed system wherein program of one site transfer a request to other programs of other sites and wait for the response of that. In World Wide Web, Web-browser (or browser) is operated in client and program which provide Web page in response to the browser's requ est is called “Web-se rver”.

TCP/IP (Transmission Control Protocol/Internet Protocol)

TCP/IP is called standard internet protocol regulating the method of two computer's exchanging the data through internet. TCP/IP processes packetization, packet addressing, handshaking and error correction etc. ISBNs 0-13-468505-9(vol.I), 0-13-125527-4(vol.II) and 0-13-474222-2(vol.III) of “internetworking with TCP/IP” of Commer and Stevens published by the Prentice Hall, Inc is referred to for more detail explanation of TCP/IP.

HTML(Hypertext Markup Language):

HTML means an assembly of code and standard coding agreement linking contribute and appending screen constitute into data content in a document. HTML 3.2/4.0 is main standard for making Web document on the filing date. HTML code (is called “tag”) is inserted into data content of document in the stage of making document. When Web document (or “HTML document”) is transferred from Web server to browser, codes are interpreted to display document by browser. Adding to describe how to display document, HTML tag can be used to create link to another Web document. This is called “hype rlink” in general. The HTML source Book (ISBN 0471-11894-4) of Ian S. Graham published by John Wiley and Sons and W3C Recommendation, HTML 4.0 regulation (REC-html40-19980424) updated on Apr. 24, 1998 is referred to for more detail explanation of HTML. W3C Recommendation information is available at http://www.w3.org/TR/1998/REC-html40-19980424/

Port or Port Number:

Port or port number is called socket number, mean identification number to induce data received by TCP/IP into specific application. Some ports are designated for specific application by the Internet Assigned Number Authority.

As an example, port 80 is designated for HTTP and used to induce received traffic into Web server.

URL(Uniform Resource Locator):

URL means a unique address designating the location of file on internet or other source. URL's general format is protocol://apparatus address: port/path/file name. Port designation is selective and browser is set as default port in regardless of what kind of protocol is designated. As an example, when HTTP is designated as protocol browser, browser will use HTTP default port 80.

HTTP(Hypertext Markup Language):

HTTP means standard World Wide Web client-server protocol used for exchanging data between browser and web server (such as HTML document and client's request for it). HTTP include the number of message that have different type each other can be transferred from client to server to request the number of server action that have different type each other. As an example, “GET” message has format of GET<URL> and provide document and file located at designated URL.

Window Operating System:

Window operating system is for executing various applications program, provides graphic based interface having uniformed appearance and instruction structure and supporting multi tasking. Each graphic based interface formed under window system is called window. Desktop window is the highest level's window representing user accessible program, file and source. Desktop window serves opening function to execute application program, to open document or file, and to start operating system. Desktop is characterized by not being minimized or closed, and maintained as full screen background always.

Active Desktop:

Active desktop is desktop window which has the characteristic of desktop window, in which various multimedia documents integrated inside and document is renewed and displayed automatically

Web Desktop:

Web desktop that have been conceptualized by the inventor, mean window controlled by specific protocol based on Web through internet, as window representing user accessible program, file and source. Web Desktop window serves opening function to execute application program, to open document or file, and to start operating system. As web desktop is controlled by desktop or Web browser without desktop and is created by makeup language, it is possible to have uniform interface regardless of kind of platform as long as makeup language is supported.

Web OS:

System is called Web Os which performs set or modification of interface configuration of client user, execution of application program, and data record management. If window system of the Microsoft corresponds to the Web OS in the invention, desktop in the Microsoft's window system corresponds to the Web desktop in the specification

Web Desktop Regulation:

Web desktop regulation means regulation defining individual user interface of Web desktop, server, and protocol between clients in the specification. Web desktop protocol includes Web desktop interface and Web desktop protocol.

Web Desktop Protocol, WDP:

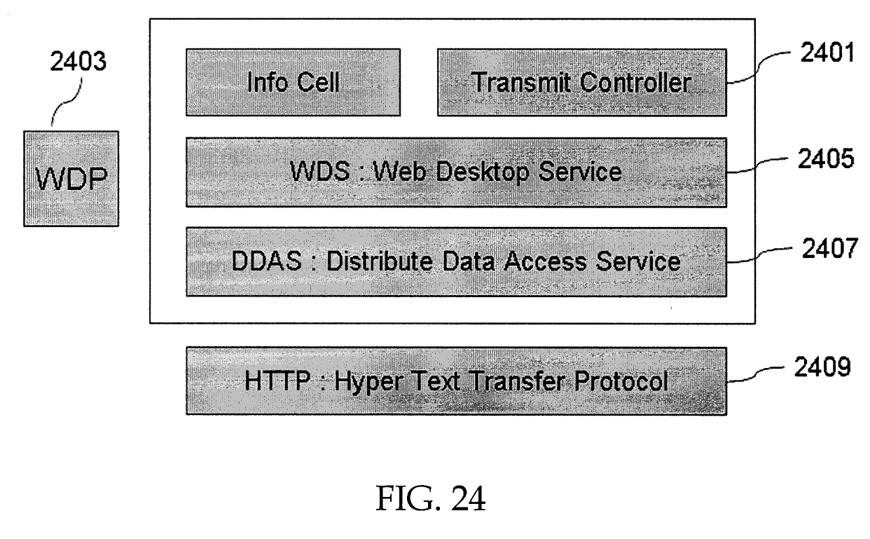

Web desktop mean all of communication structure to embody individual user interface of Web desktop, data structure, and data control in the specification. Web Desktop Protocol (WDP) is embodied through architecture as illustrated in FIG. 24. The more detail explanation is as follows

Action and Event:

Input action that is taken in client by pointing apparatus such as keyboard, button, and mouse and occurs in client in which Web desk top is loaded on and being executed, is call event, and the abstract action that user take in Web interface is called action. As an example, considering user move a icon in Web desktop to a folder, the what move icon to folder is action and individual input action such as user's moving pointer on display apparatus to icon, click button of mouse, moving mouse with clicking button, moving icon to folder position with clicking button, or finally released the button is event. In other words, the action comprise event of moving icon to folder comprise mouse movement, button click of mouse, and releasing the button.

2. Environments Wherein the Desktop According to the Present Invention can be Adopted

(1) Communication Environment

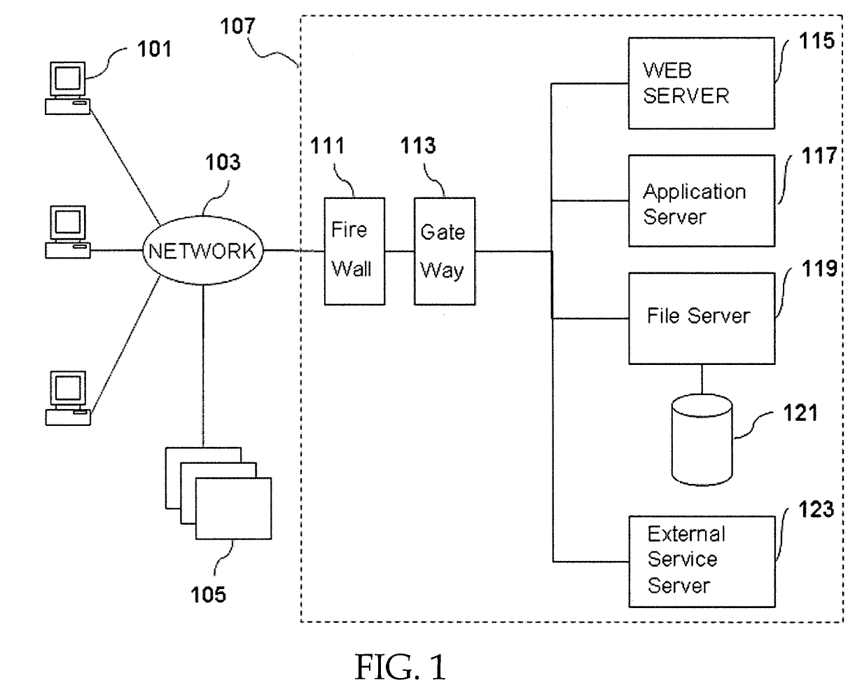

FIG. 1 is a block diagram illustrating total communication environment to provide Web OS, or Operating System using network according to the present invention.

Total communication environment is a server client model including server (107) and numerous clients (101). Server (107) and client (101) connected with each other through at least one network(107). WAN (Wide Area Network) provided by at least communication company is a typical example. Network (103) allow dispersed client users to connect with server (107). Preferably, Network can be one of x.25, ISDN, frame relay interface, and TCP/IP protocol net.

(2) Server

Server (107) include numerous lower servers(115, 117, 119, 123) connected to high speed LAN(Local Area Network). Also, server (107) includes gateway (119) to link the signal received from client(107) to lower server. Preferably, numerous lower servers (115,117,119,123) and gateway include a processor provided by the Microsoft. The spirit of the present invention is not limited to window system and can be applied to all types Operating System providing internet connection environment (such as Window system, or Mac system).

Server (107) provides Operating Service based on information or communication infrastructure to each client, that is, Web OS. According to one embodiment of the present invention, service that the server(107) provides includes individual client configuration set and register service, configuration modification service according to client's performance, resource providing service of which client can make use, application program providing service to client, multi data streaming service for client to play multimedia data in real time, BBS (Bulletin Board System) service to upload document from client and to modify it, and messanger and chatting service to exchange messages between client users in real time.

A Lower server may comprise Web server(115) to execute Web service to client, application server(117) to provide application to client, and file server(119) to manage and store data received form client according to client request, and exterior service server(123) to manage service provided from exterior.

(3) Client

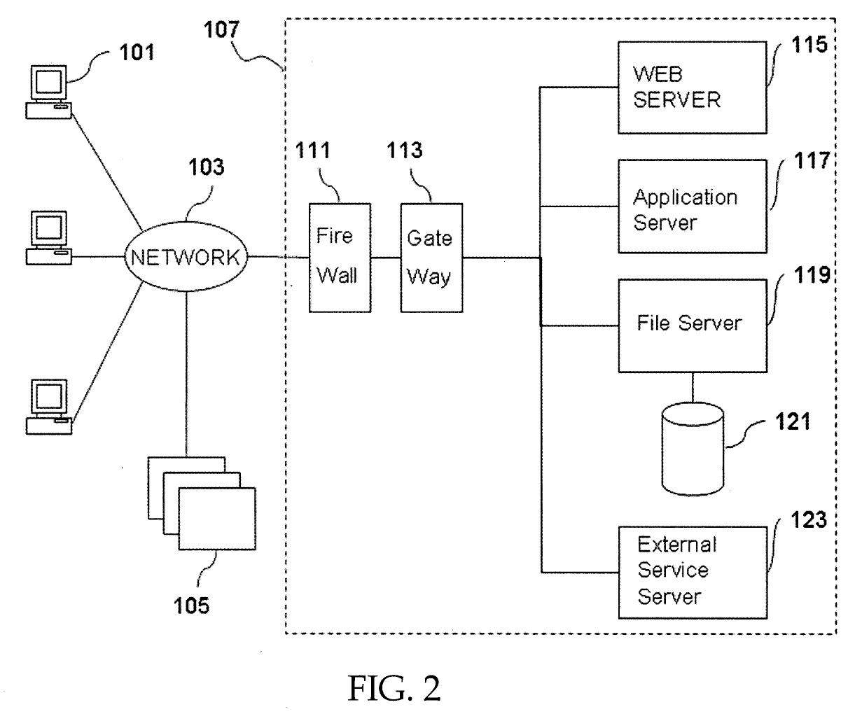

FIG. 2 is a block diagram illustrate client's(101) constitute to operate the Operating System using network, the Web OS according to one embodiment of the present invention.

Referring to FIG. 2, client (101) according to one embodiment of the present invention comprise computer (222) including at least a CPU(224), memory system(226) connected to CPU(224), input part(228), and output part (230). These components connected with each other by at least a bus structure (232). The illustrated CPU(224) include ALU(234), register assembly for temporary memory of data and instruction, and control part(238) for controlling system(220). CPU (224) may be one architecture of among Alpha of Compaq, MIPS of MIPS Technology, NEC, IDT, or Siemens, x86 of intel, Cyrix, AMD, or Transmeta, PowerPC of IBM, or Motorola, SPARK of Sun Microsystems.

Memory system (226) includes rapid main memory (240) comprising medium such as RAM or ROM, and 2_{nd} storage (242) to store data using electrical, magnetic, or optical record medium such as floppy disk, hard disk, tape, CD-ROM, flash memory. Main memory (240) may include video display memory to display image on display apparatus. Skilled person in the field to which this present invention pertains understand that memory (226) can include substitutes having various storage capacity.

Known Input apparatus (228) may includes keyboard, mouse, physical transducer (ex, micro phone). Known output apparatus (230) include display, printer, transducer (ex, speaker) and so on. For Input apparatus or/and output apparatus, apparatus such as network interface or modem.

Clients of this specification are interpreted to include all apparatus comprising CPU (224) and memory system (226). Clients of this present invention include the PC system compatible with IBM, computer of APPLE Inc., PDA based on PalmOS of Palm, Inc.(ex, Palm series, Visor series of Handspring, Clie series of Sony and so on), PDA supporting windowCE of Mircorsoft (ex, iPaq of Compaq, jornada of HP, and Thin Client). Client comprise computer system, input apparatus (228) and Output apparatus (230) (ex, IBM compatible PC, computer system of APPLE, PDA and so on), or, comprise only computer system (220) (ex, Thin client).

As known to skilled person to which the present invention pertains, computer system (220) includes at least an application program and Operating System.

Operating System is the assembly of software controlling operation of computer system and allocation of source. Application program is an assembly of software to work that user desire, use computer resource accessible through operating system. Both reside in memory system (226) illustrated in the drawings.

In the specification, action of computer system (220) and abstract expression of behavior are referred to for explaining the invention in general. Depend on the case, these action and behavior can be explained as what executed by computer. These operation expressed abstractly include maintenance of data bit in the memory area in memory system(226) and CPU's electrical signal causing modification or reduction of electrical digital signal expressing data bit for restructuring, modifying or processing the other signal. Memory area wherein data bit remain is physical area having specific electrical, magnetic, or optical attribute corresponding the data bit.

3. Web OS Architecture of the Present Invention

(1) Network Architecture

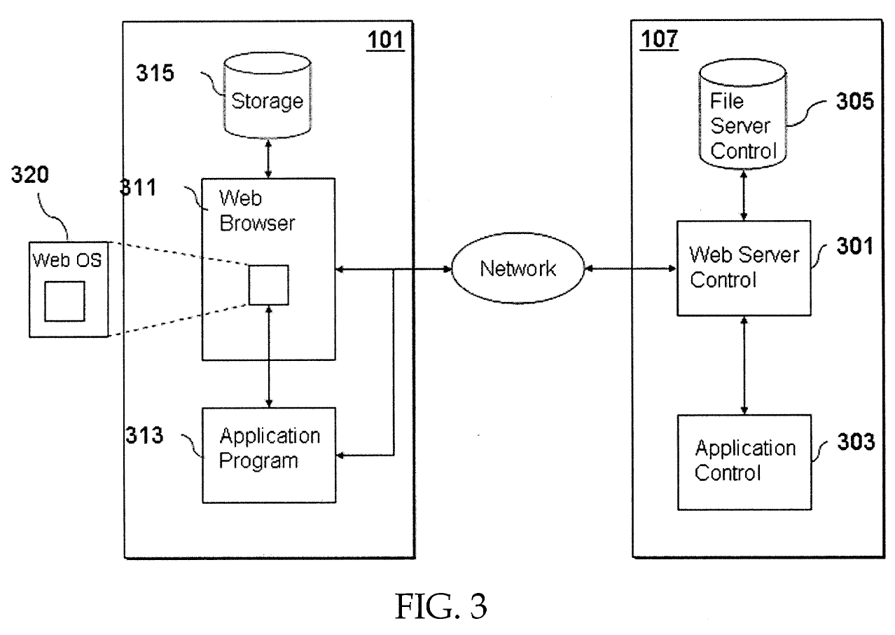

FIG. 3 is a block diagram illustrating one embodiment of network architecture of Web OS.

The architecture of Web OS comprise components of server (107) and client(101) side.

Server's component include Web server control (301), application control(303), and file server control(305). Web server control (301) and application control(303) can be embodied as program executed in server(107). Environment illustrated in FIG. 1, it is preferred that each server (107)'s component should be handled distributive by each lower server.

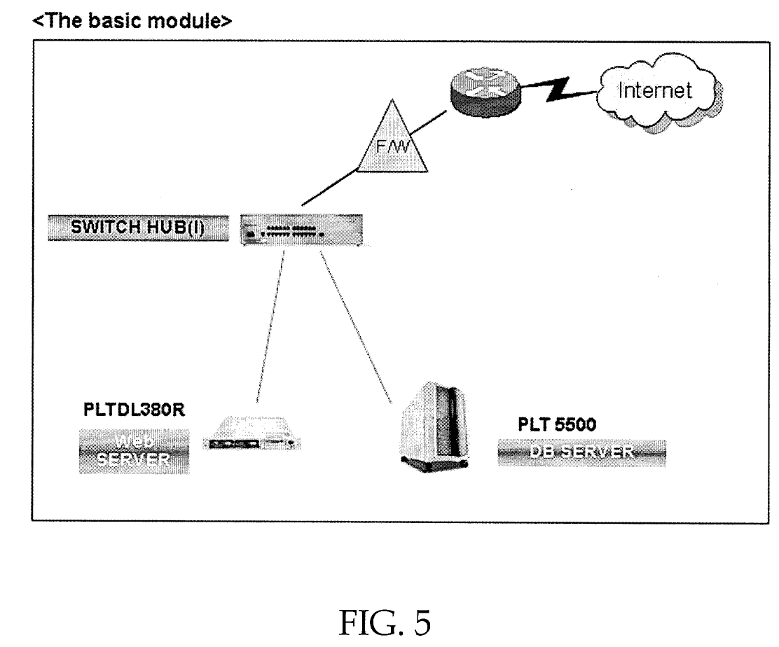

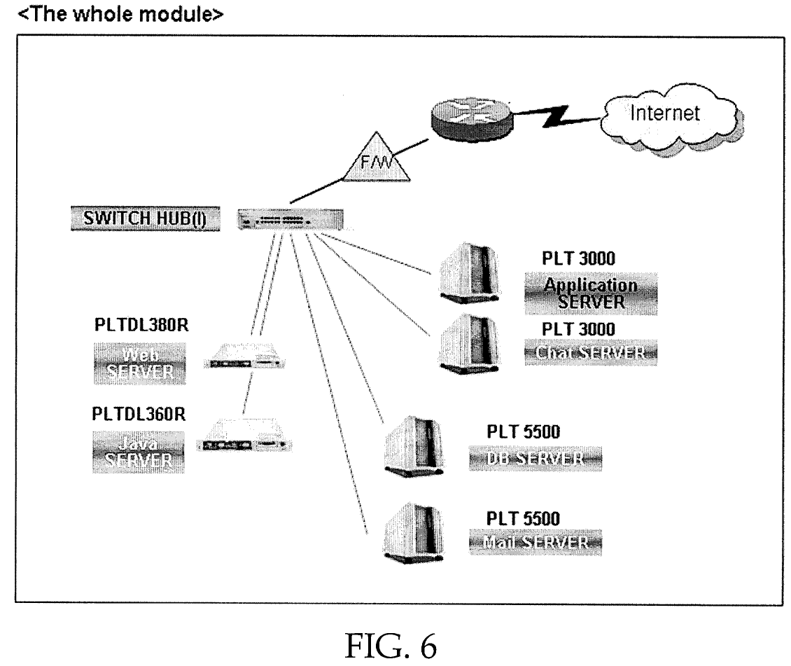

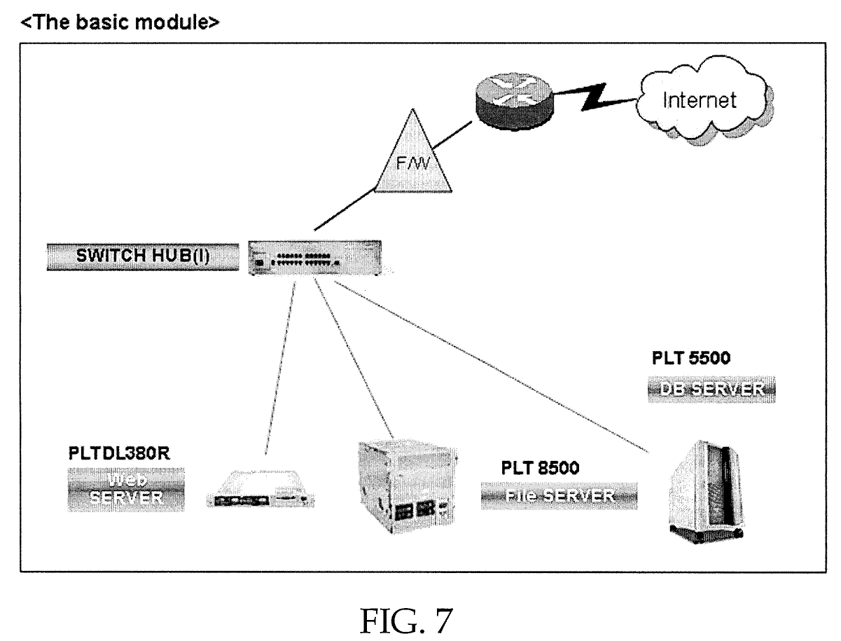

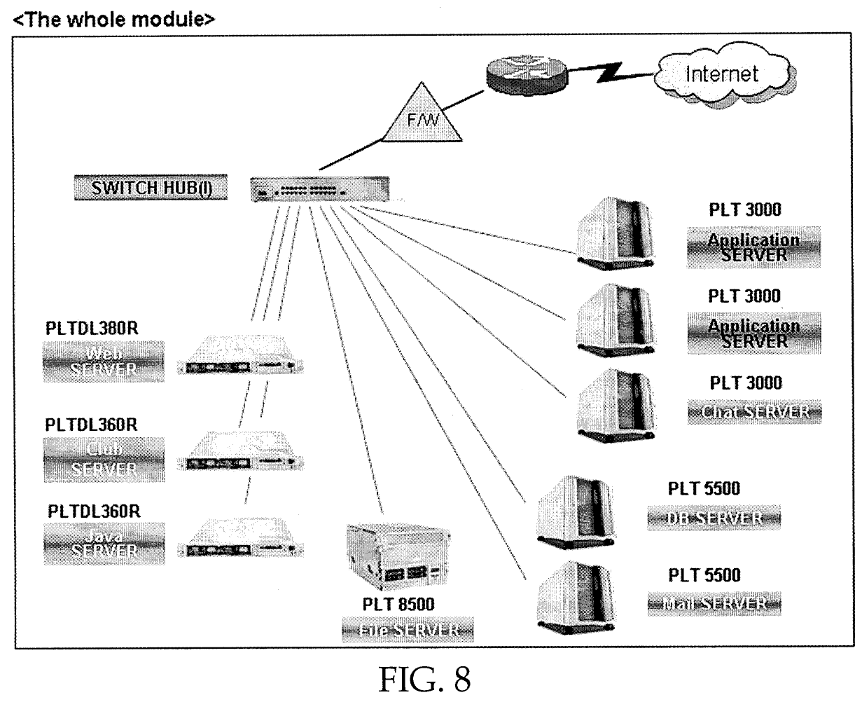

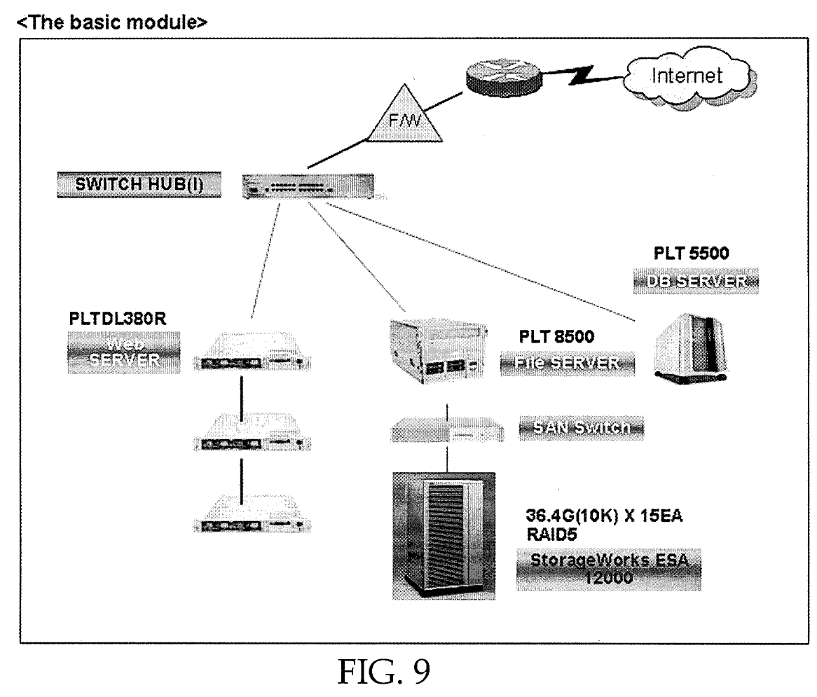

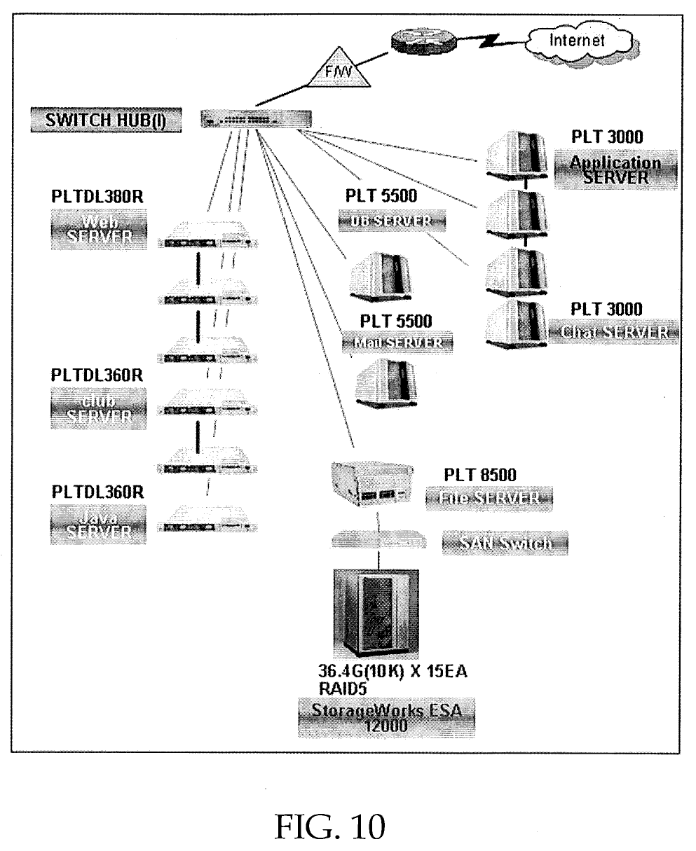

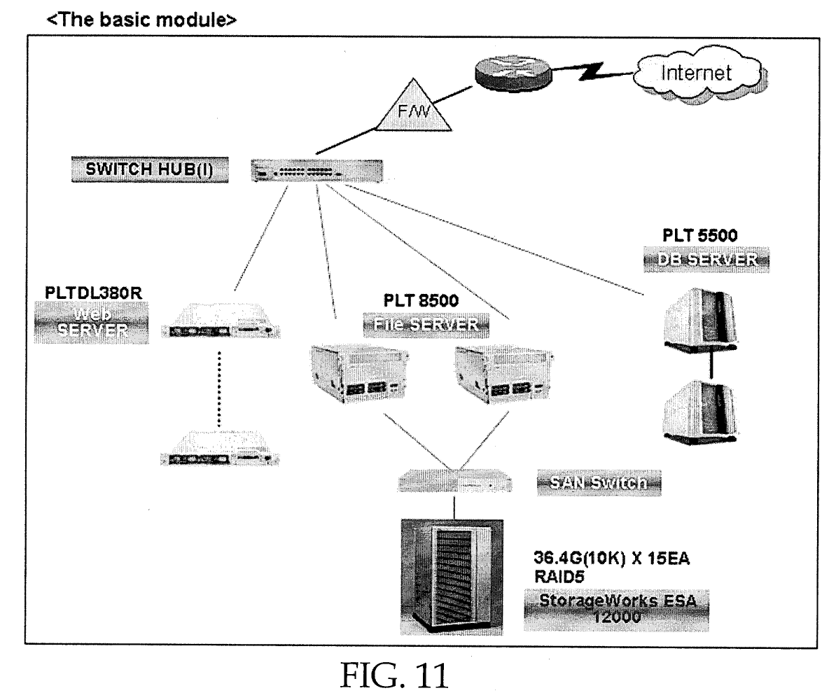

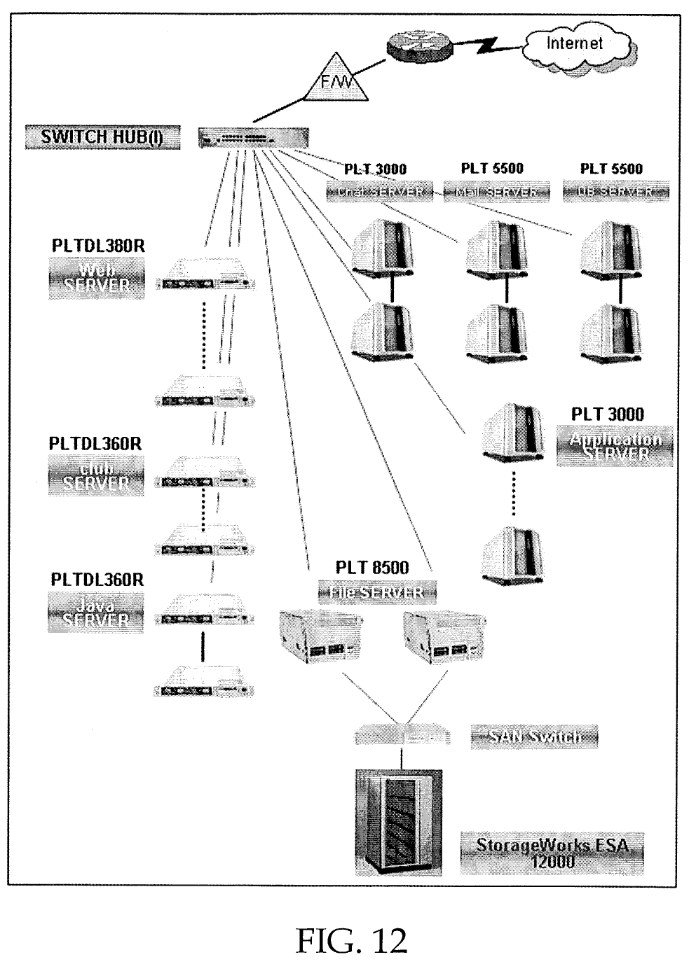

FIG. 5 to FIG. 10 are block diagrams illustrated server (107)'s component of Web OS architecture in embodiment designed according to the number of user.

Client's (101) component include Web browser program (311), application program(313) and storage(315). Also, Web browser program (311) and application program(313) can be embodied as program executed in client (101).

According to a preferred embodiment of the present invention, Web browser program (311) display window on client's display mean (230) based on information provided by Web server control (301). Displayed Widow takes the form of desktop, which is named Web desktop as stated above in the specification.

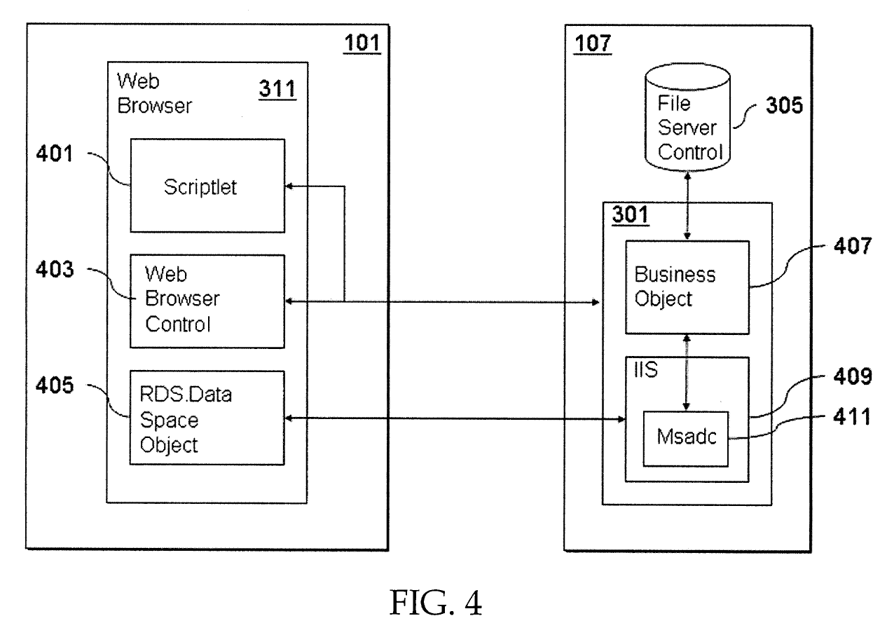

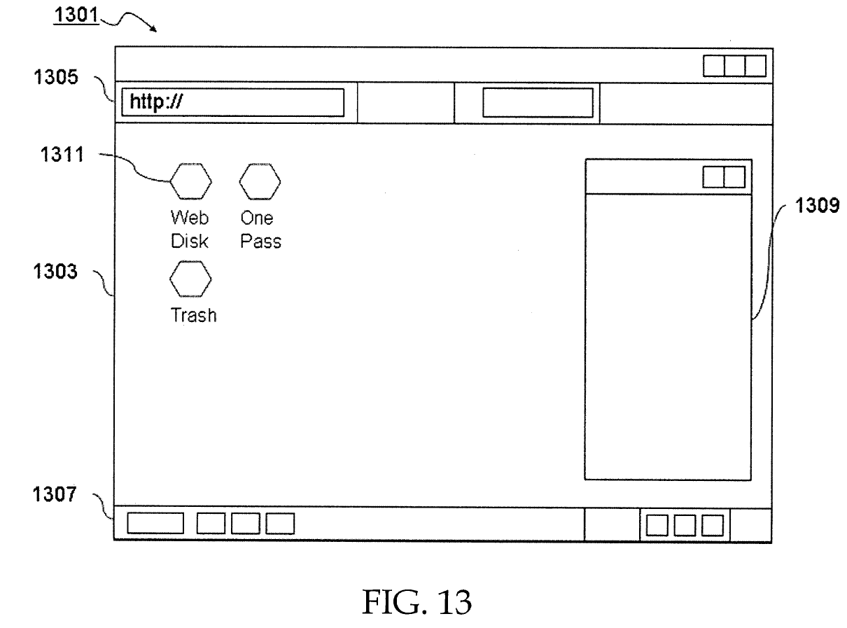

FIG. 13 illustrates what Web desktop according to the present invention is shown on display mean (230) in physical. Referring to FIG. 4, the detail explanation of server-client network architecture to manage and display Web desktop interface at display means (230) as illustrated in FIG. 13 is as follows. FIG. 4 is a block diagram illustrating schematically a prefer embodiment of network architecture to manage Web desktop interface. In FIG. 4, the explanation of constitutes duplicate in FIG. 3 are omitted and the network duplicate in FIG. 3 is not illustrated.

As illustrated in a FIG. 4, network architecture to manage Web desktop interface include server's (107) component and client's (101) component.

Client's (107) components include IIS module (409), Msadc (422), and business object (407) executed in Web server control (301)

Client's component comprise component control technology using scrip executed in Web browser(311), such as scriptlet (401), Web browser control(403) and RDS data space object(405).

Scriptlet (401) and Web browser control (403) communicates with Web server control (301) through network not shown.

RDS data space object (405) communicates with IIS module (409) according to RDS protocol.

In IIS module, Msadc (411) handles communication with business corn object.

(2) Server Architecture

The more detail explanation of server architecture (107) to execute Web OS according to the present invention is followed

Web server control (301) records template defining user interface components to display on client based on predetermined regulation to recording medium by individual user. Template defining user interface component which Web server control (301) records comprise interface attribute component and user information component.

Web server control(301) transform template of user who connect through the client (101) recorded by file server control(305) into mark up language, such as HTML format, and provide it to client in response to the client(101)'s request. Web server control functions as DHTML server providing data of HTML format type dynamically.

(3) Client Architecture

The following are the more detail explanation of client (101) architecture to execute Web OS according to the present invention

Web browser program (311) start login session when connects to server (107). In login session, Web browser program (311) transmits login data of user to server. Web server program (311) interprets makeup language such as HTML data and shows it on display mean (230). Interface on display mean (230) by Web browser program (311) have uniform shape regulated by Web desktop protocol according to the present invention.

(4) Service Architecture

FIG. 24 is a block diagram illustrating service architecture of Web OS according to the present invention.

OS system according to the present invention, or service architecture of Web OS have hierarchic structure of cell layer (2401), Web Desktop Protocol (WDP) layer (2403) and client server protocol layer(2409).

WDP layer (2403) comprise Web Desktop Service layer(2405) to handle cell traffic and Distribute Data Access Service(DDAS) layer(2507) to process distributed data access.

Web layer (2401) define cell transferred through WDP. According to the present invention, cell layer (2401) comprises data cell for data structure and Transmit Control Cell for data control.

WDP layer(2403) is to transfer cell belong to cell layer(2401) to embody Web desktop interface and so on according to the present invention.

Distributed Date Access Service (DDAS) layer (2507) mean service to manage access distributed data. DDAS layer manage cell transfer by controlling WDP layer. According to one embodiment, if internet Explorer is adopted as Web browser of user terminal, Remote Data Service (RDS) of the Microsoft as DAAS can be adopted.

Client server protocol layer (2409) means physical layer to control cell transfer. HTTP can be used as client server protocol layer (2409) according to the present invention.

4. Interface of Web Desktop According to the Invention

(1) The Whole Configuration of Web Desktop.

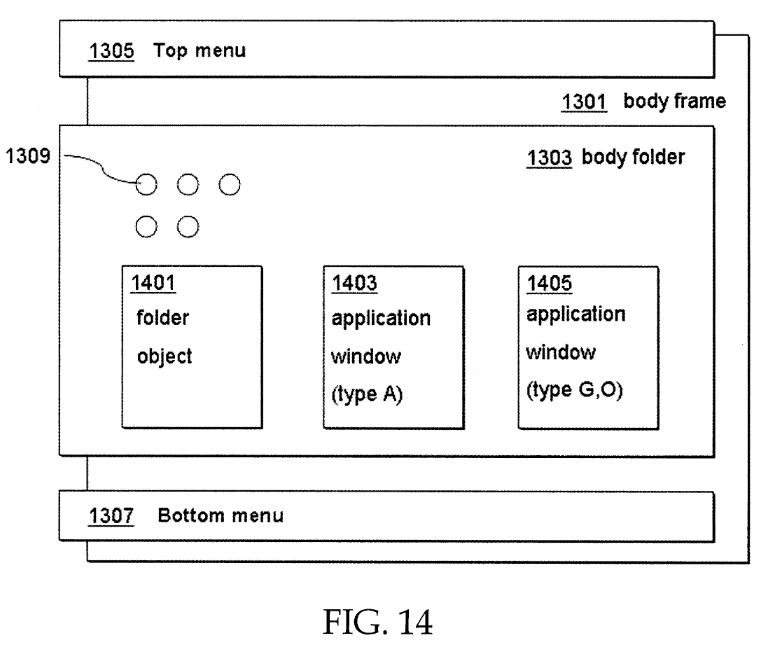

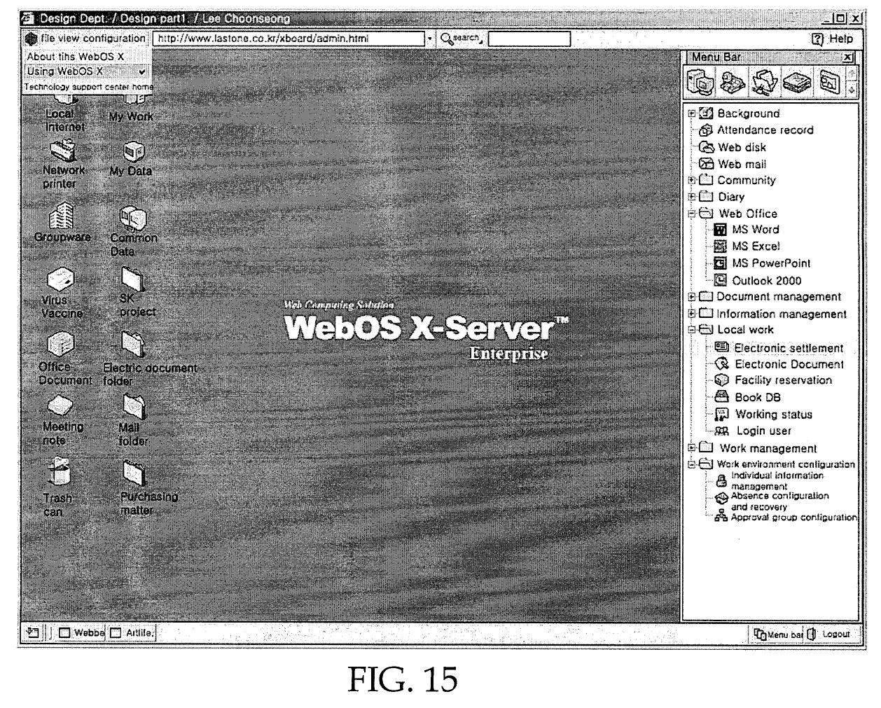

FIG. 13 illustrates schematically Web desktop interface according to the present invention. FIG. 14 illustrates schematically constitute of Web desktop interface according to the present invention. FIG. 15 illustrates one embodiment wherein Web desktop interface displayed on screen.

As illustrated at FIG. 13 and FIG. 14, Web desktop interface component comprise main body frame (1301), main body folder (1303), menu bar (1305, 1307), lower object (1309) and icon (1311).

According to another embodiment of the present invention, menu bar can be divided into a top menu (1305) and a bottom menu (1307). It is preferred that A top menu (1305) and a bottom menu(1307) have each function individually.

Also, as illustrated in FIG. 14, Lower object (1309) can comprise folder object (1401), A type application window (1403), and G and O type application window (1405).

Web desktop interface component according to the present invention is preferred to be based on scriptlet.

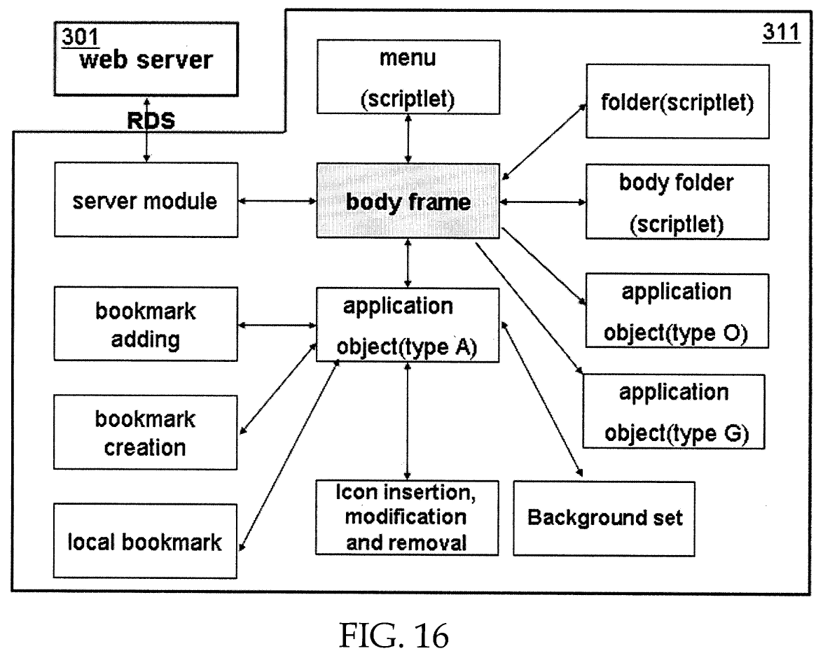

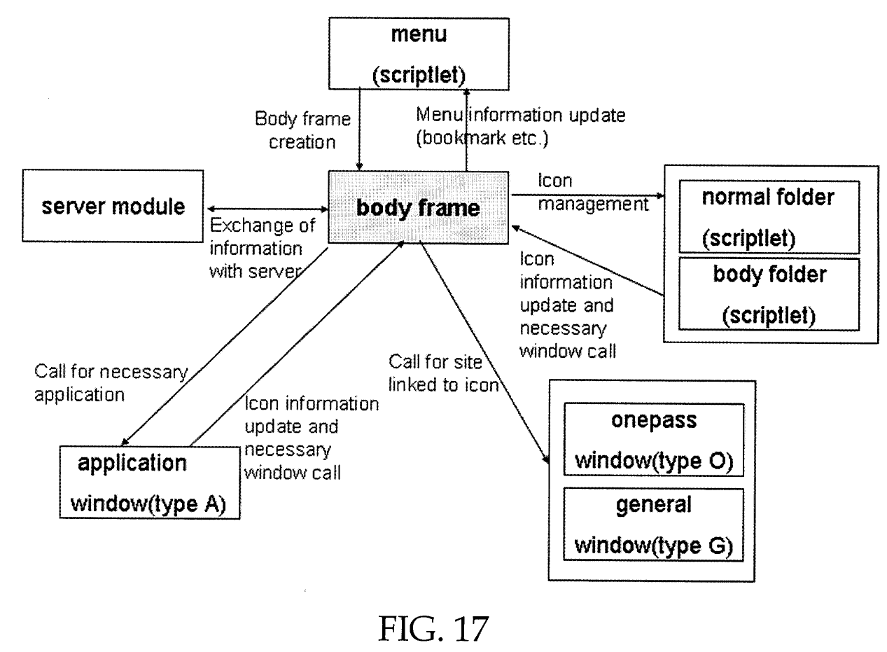

FIG. 16 illustrates object and procedure to embody Web desktop interface according to the present invention. Each procedure is preferred to be carried out under the control of Web browser. FIG. 17 illustrates schematically communication between each object and procedure of Web desktop interface according to present invention.

As illustrated in FIG. 16 and FIG. 17, Web desktop interface according to the present invention is handled by communication between main body frame and other object or procedure.

Main body frame (1301) transmits icon management information to main body folder (1303), and main body folder (1303) and folder object (1401) transmit icon information, icon renewal information, and request for calling window.

Main body frame (1301) object transmits menu renewal information, and menu bar (1305, 1307) object transmit request for forming main body frame to main frame (1301).

Main body frame (1301) object transmits call of desirous application program to A type application among lower object(1309), and A type application window(1403) transmit the icon renewal information and call of desirous application program.

Main body frame (1301) object transmits call for site linked with icon clicked to O and G type application among lower object (1309).

Server module transmits and receives necessary data to server (107) on communicating with main body frame (1301).

The following is the detail explanation of object and procedure comprising Web desktop interface according to the present invention in order of main body frame(1301), and main folder(1303), menu bar(1305, 1307), lower object(1309), icon(1303), and server module.

(2) Main Body Frame

Main body frame (1301) is a basic frame to call other interface components or frames. Main body frame (1301) is an abstract frame that user do not recognize among interface. Main body frame (1301) forms the background of Web desktop in Web desktop.

Main body frame (1301) functions as medium which allow other interface component to communicate data or order each other.

As stated above, each interface component formed based on scriptlet which can communicate with other module through upper frame called itself. Therefore, medium to mediate communication between them is necessary and what performs this function is the main frame.

As an example, when top menu bar (1305) needs to be modified as action occurs that A type application window (1403) modify bookmark, Bookmark modification info is transmitted to top menu bar (1305) through main body frame.

Also, when folder object (1401) makes instruction of calling new object window, the call instruction is transmitted to new window object through main body frame. As an more detail example, when application program connecting specific URL, such as yahoo, is executed by opening folder object, the event of double clicking the icon of application program occurs and the connection info is transmitted to main body frame and main frame activate new application window based on this information.

(3) Main body folder

Main body folder (1303) forms the background of Web desktop interface in the main frame. Main body folder (1303) is the lower object of main flame hierarchically.

Preferably main body folder (1303) has same level as folder object (1401) and application window (1403, 1405) hierarchically. Though FIG. 14 illustrate that main body folder (1303) is created as upper layer of application windows (1403, 1405), it is just on the screen that main folder (1303) is displayed on folder object (1401) and application windows (1403, 1405). In respect of order call structure or communication relation, main body folder (1303), folder object (1401) and application windows (1403,1405) is located under main body frame(1303). Object such as folder object (1401) and application windows (1403, 1405) displayed on main body folder communicate with main body frame (1301) directly without bypassing main folder (1303).

Depend on case, main folder is handled as one sort of a big folder object.

(4) Menu Bar

Menu bar means a hierarchical object assembly to carry out action such as input of instruction and call for application in Web desktop interface.

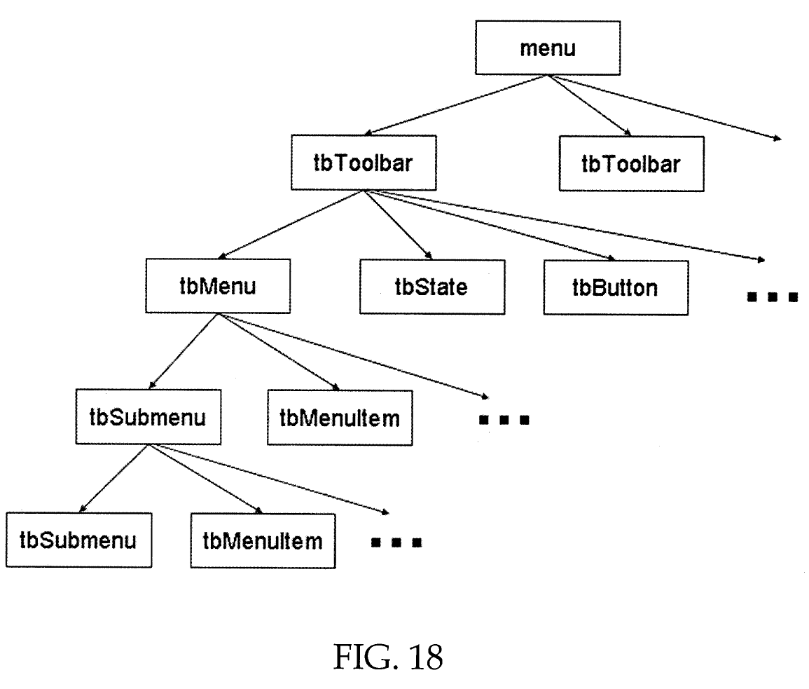

FIG. 18 illustrates the hierarchy of menu bar in Web desktop interface according to the present invention.

Tool bar object means the one conceptual group formed by collecting selected menu.

The highest menu (tbMenu) object is displayed on the tool bar object, and mean what user can access on the interface in the first.

Sub menu (tbSubMenu) object are the other menu object except the highest menu object, and mean lower menu object which called from upper menu object and are displayed as popup menu type

Menu item (tbMenultem) object acts independently and mean menu object that does not accompany lower menu object.

State (tbState) object acts independently, and mean menu object that display active window on lower menu.

Button (tbButton) object acts independently, and mean menu object in which next instruction is displayed as a button and does not accompany lower menu object.

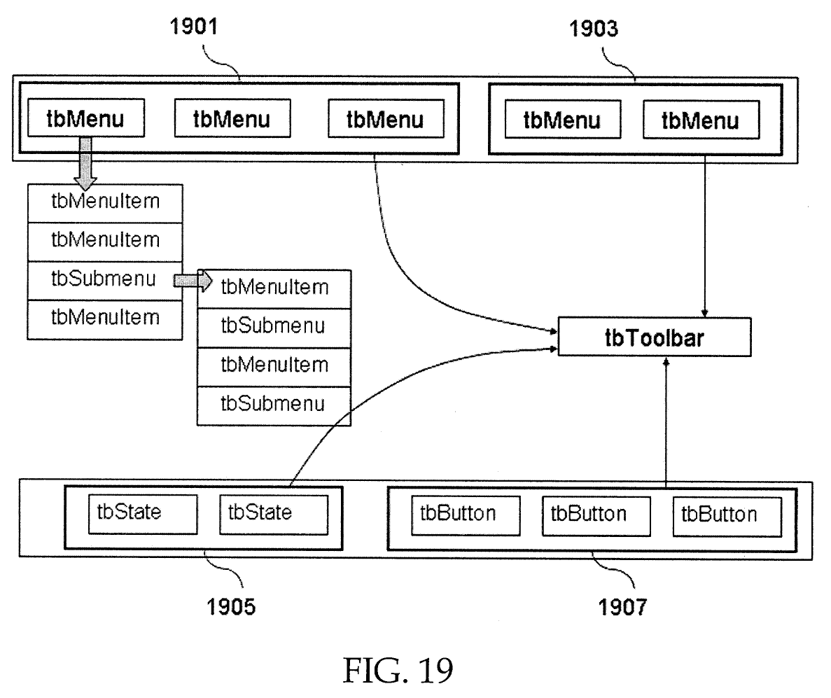

FIG. 19 illustrate an example in which menu bars are displayed on the Web desktop interface according to the present invention

As illustrated in FIG. 19, four tool bar objects are displayed. Tool bar object (1901, 1903) are displayed at the top of the main body frame (1301) and form the top menu (1305), and tool bar (1905) and tool bar object (1907) are displayed at the bottom of main body frame (1301) and form bottom menu (1307). Tool bar (1901) and tool bar object (1903) have three and two highest menu bar object respectively. Tool bar objects (1905, 1907) have two state objects and three button objects respectively.

(5) Lower Object

Lower object (1309) means object of the lower hierarchy object excluding main body folder (1303) and icon (1311) under main body frame (1301). In broad sense, main body folder (1303) and icon (1311) could be defined by being belonged to the lower object.

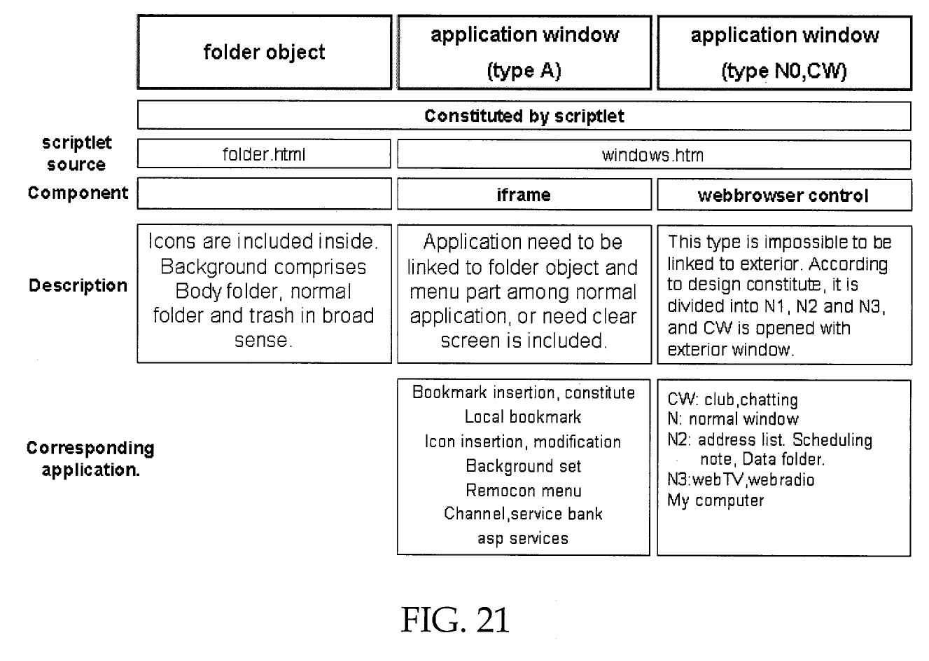

FIG. 21 is a table showing scriptlet source, component, explanation and relevant application of folder object (1401), A type application window object(1403), and G and O type application window object(1405) among lower object(1309) of Web desktop interface respectively.

A type application window object (1403) among application window object means application window that can communicate with other objects. The other application windows do not communicate with each others and just receive data from main body frame (1301).

(6) Icon

An Icon mean is object which is displayed on main body folder (1303) or folder object (1401), and which executes application program or links the connection to specific URL.

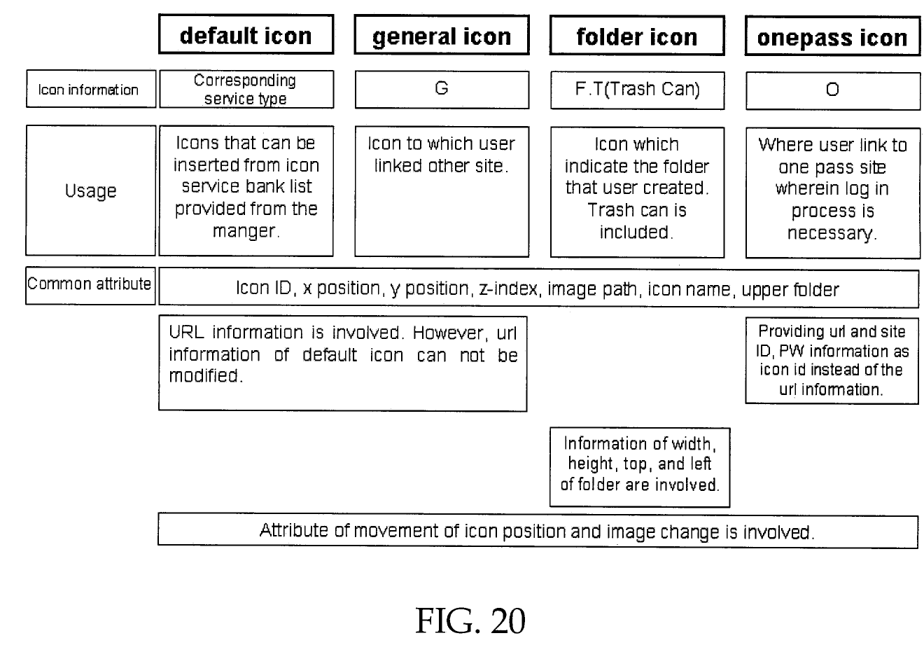

FIG. 20 is a table showing icon information, usage, common attribute, and characteristic attribute of each icon type formed on the Web desktop interface.

(7) Server module

Server module transmit data from main frame (1301) to server (107), or reversely. Server module include server module (1501) communicating with Web server control (1301) by DDAS protocol, such as RDS protocol. Data transmitted from the client (101) to server (107) through server module are as followed.

1. On adding icon: icon ID, x-y coordinate, upper folder, image, icon name.

2. On deleting icon: icon ID

3. On modifying icon information: icon ID, x-y coordinate, upper folder, image, icon name, url, id, pw of one-pass icon

4. On creating Bookmark: bookmark ID, url, upper folder

5. On deleting bookmark: bookmark ID

6. On modifying Bookmark: bookmark ID of all bookmarks. Upper folder, sequence.

7. On modifying information of background: background color, text color, background image, whether image repeat or not, and default.

Data transmitted from the server (107) to client (101) through server module are as followed.

Site URL, site ID, and site password on executing one-pass application (it is preferable that these data are not stored in client for security)

5. Operating Process of Web Desktop According to the Present Invention

(1) Data Unit of WDP Protocol

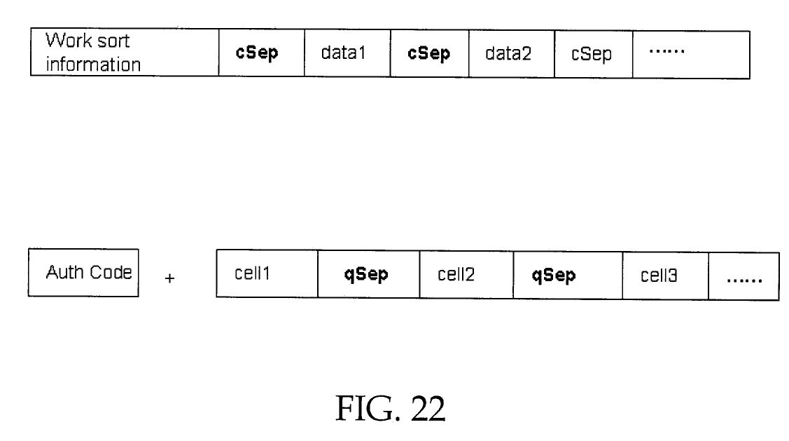

FIG. 22 illustrates the structure of data cell transmitted to server (107) and unit cell structure of data that server module make to transmit to server (107).

In the present specification, Unit cell of data, or data cell is unit cell that match a work done in client to WDP. As an example, when action and event of moving of icon or adding bookmark occurs, server module makes data to transmit this data to server through WDP and unit of data is data cell in this time. It is preferable that data cell include data field illustrating necessary data to handle the action field showing relevant action's ty pe and action.

According to the present invention, unit of data transmitted from server module to server by distribute data access hierarchy is called data unit. Data unit have a form of assembly of authentication code and code for user authentication code. Authentication code is for user authentication.

Data unit cell that server module makes include work sort information field, data separation field (cSep), and data field (data n). Preferably, data separation field (cSep) and data field (data n) is configured crossly next to work sort field. According to one embodiment, data separation field (cSep) is blank ASCII string in size of 29 characters.

A data unit that Server module transmits includes user authentication code, cell field (cell n), and cell separation field (qSep). Preferably, cell separation field (qSep) and cell field (cell n) are configured crossly next to user authentication code field. User authentication code is for authenticating user, is preferable to comprise user ID, ASCII string in size of 15 characteristics and section key value. According to the present invention, cell separation field (qSep) is blank ASCII string in size of 18 characters.

According to the present invention, it is preferable to control transmission of the data according to degree of importance. According to one embodiment of the present invention, data unit cells are divided into critical cells or non-critical cells according to characteristic of data to be transmitted. Thereby, transmission control is performed with division of data unit cell.

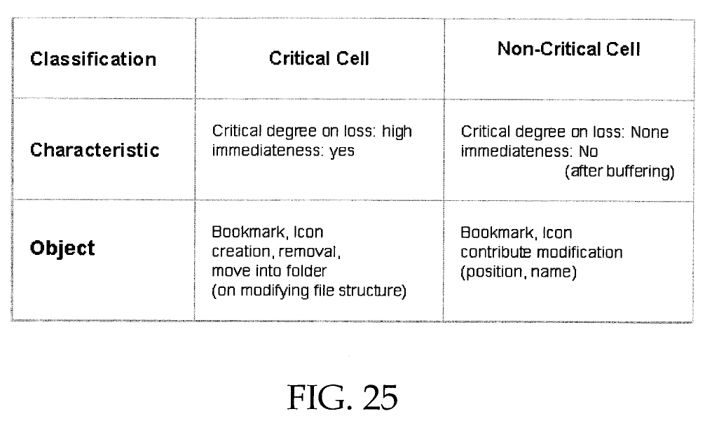

FIG. 25 is a table to explain an example of the object and criterion to divide the data unit cell into Critical Cell and Non Critical Cell. As illustrated in FIG. 25, according to the characteristic of data to transmit, data unit cell are classified as a Critical Cell If it is critical when lost, and If not, Non Critical cell. Or, data need to be transmitted immediately is classified as a critical cell, and otherwise, as a Non critical cell.

According to this criterion, data transmitted by critical cell may include bookmark, icon creation and deletion, moving into the folder such as modifying of file structure. Also, data transmitted through a non critical cell include modification of attribute of bookmark or icon, such as position and name.

According to a preferable embodiment of the present invention, server module have means for judging whether a critical cell or a non critical cell. The method of judging whether a critical cell or a non critical cell comprise creating lookup table recording list of critical and non critical list, and judging occurring cell belong to which side of table. On this occasion, it is possible to judge whether it is a critical cell or a non critical cell by referring to the action type field of created cell.

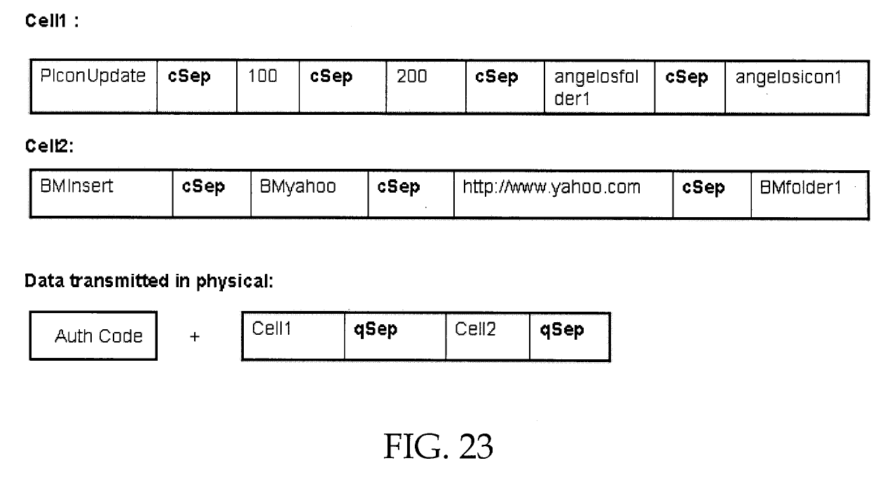

FIG. 23 illustrates an example of data unit transmitted in physical and cell created in the process of transmission to server. FIG. 23 illustrates a cell for that user move the icon having identifier “agelosicon1” to (100,200) of “angelosfold er”, and a cell and data unit for transmitting order to add bookmark linking to URL http://www.yahoo.com.

(2) Transmission Control of WDP Protocol

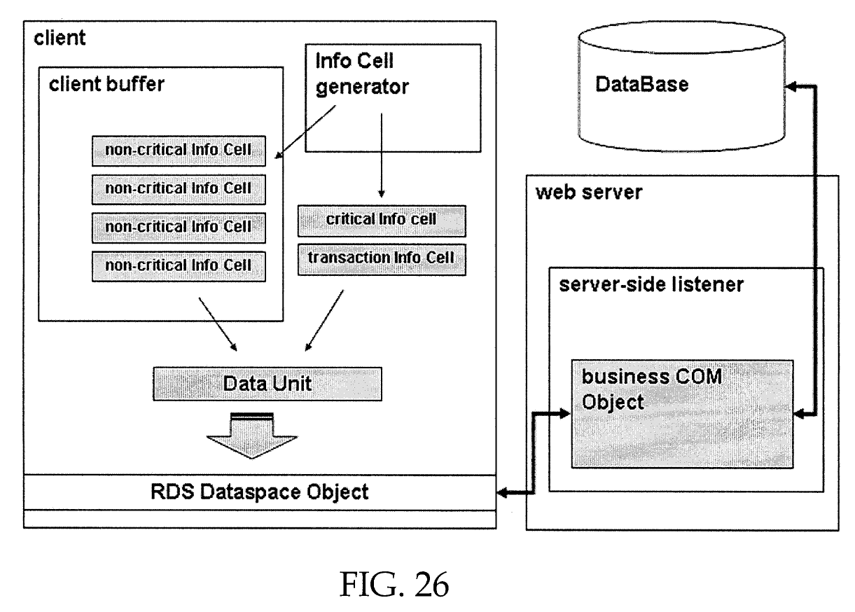

FIG. 26 is a block diagram to explain the transmission control procedure of data by WDP protocol.

In the specification, transmission control relates to the process of data, especially means process of effective data transmission and reliable handing. More specifically, transmission control is judging the time and size data cell that created in client on being transmitted to server or client , and processing transaction in combination of meaningful data and authentication procedure in process.

Numerous data occur when action or event that user make is transmitted to server while maintaining user interface of Web desktop. As an example, numerous data cells are created while user move icon on Web desktop, or drag and drop bookmark.

The object of transmission control is to reduce the traffic of communication through managing effectively numerous data cell or data unit occurred in Web desktop.

It may be not preferable to transmit data cell immediately when created in respect of Web desktop operation according to the present invention.

The reason is that it does not burden the operation of Web desktop if connection to server does not close because client's work is performed in client mostly. However, there are some cases wherein created cell is to be transmitted to server immediately. As an example, the case is creating folder on the background of Web desktop. In this case, when data of action of creating folder on background is not transmitted immediately, it is possible that it have the irrecoverable damage of losing the moved icon, or, the recovery of background folder structure is impossible.

As illustrated in FIG. 26, data cell creator and buffer is provided in client (101) to transmit data through WDP protocol. Data cell creator make cell that correspond to data for transmission according to various actions or events occurred in client side.

Thereafter, whether the created cell is a critical cell or not is judged. One embodiment of the present invention makes lookup table to judge whether it is a critical action or not according to type of action, and then judges whether it is a critical action or not by referring to the work type field of created data cell.

Non critical cell among data cell are stored in buffer. After that, client (101) create data unit by combing non critical cell stored or not stored in buffer and transmission data cell. Created data unit is transmitted to server through distributed date access service object embodying distributed date access service (DDAS) layer (2507). For distributed data access service object, RDS data space object can be used.

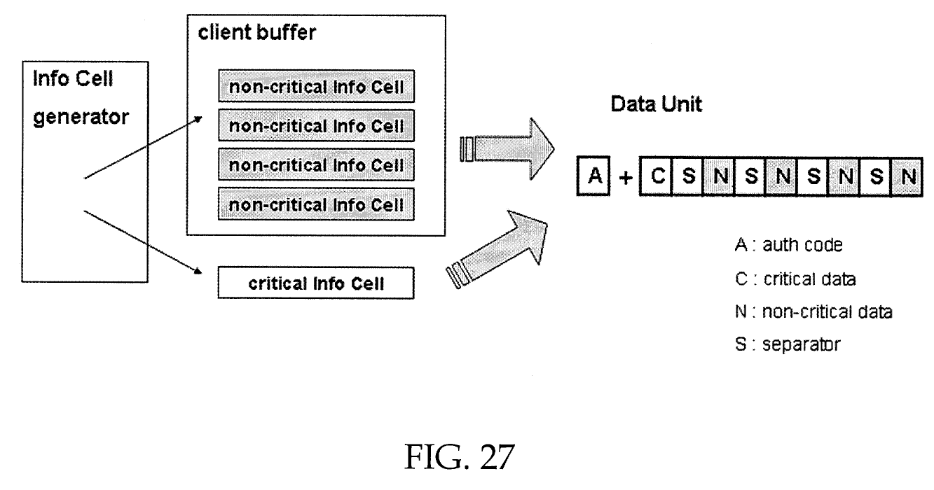

FIG. 27 illustrates the more detail procedure of creating data unit by combining the critical cell and the non critical cell. According to one embodiment of the present invention, when a critical cell is created in data cell creator, the critical cell is stored in buffer and is combined with at least a non critical cell. Then, the server creates data unit by combining the critical cell and the non critical cell.

According to one embodiment of the present invention, as illustrated in FIG. 27, data unit comprise authentication code, critical cell, at least a non critical cell, a critical cell and separator for breaking away a non critical cell.

In an above embodiment, it is stated that the non critical cell is stored in buffer, Then data unit is created when critical cell occurs and is transmitted to server. However, the spirit of the present invention is restricted by the embodiment. According to another embodiment, the timing when the data unit is created and transmitted to server can be modified. As an example, data unit can be created and transmitted when the number of critical cell exceeds the predetermined figure, or when the number of stored non critical cell exceeds the predetermined figure.

Server listener is provided to server's side. Server's listener waits for the data transmission, parses data unit received form server and process a relevant work, action or event. According to one embodiment, business COM object is used as server's listener. Server receive data unit transmitted from client (101) through server's listener. Server renews or modifies the data in database according to data interpreted by received data unit.

(3) Web Desktop Interface Display and Operating Process

The following is the procedure of displaying and operating Web desktop interface in client.

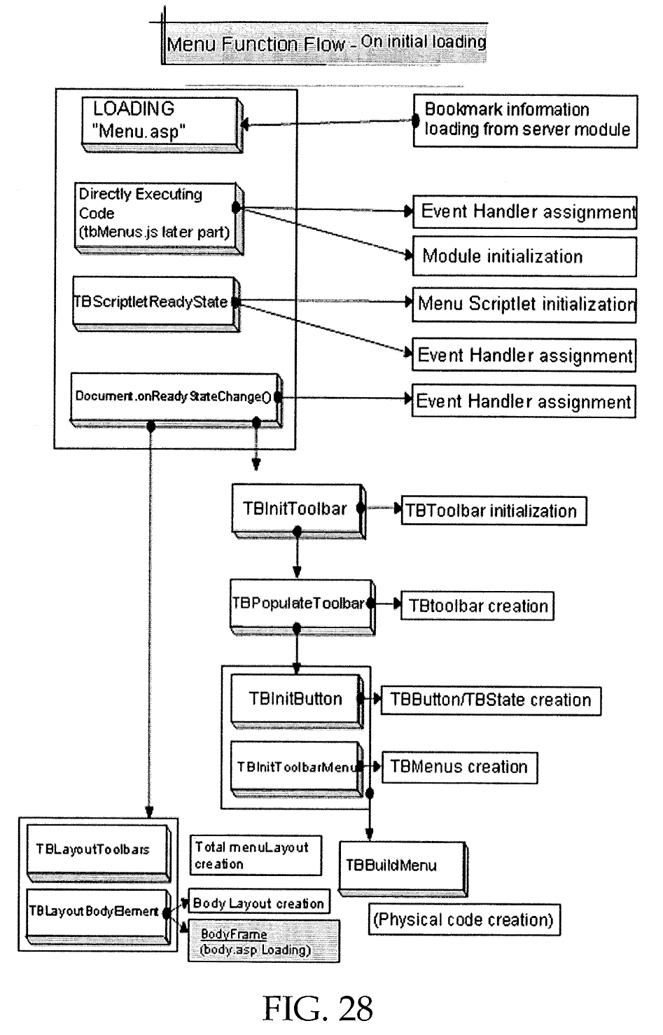

According to the present invention, FIG. 28 is a flow chart illustrating the subroutine call procedure relevant with menu bar component when Web desktop interface is loaded on client.

As illustrated FIG. 28, “Menu.asp” is loaded at first. At this time, bookmark data is loaded form server module. After that, Directly Executing Code procedure is executed. At this time, Event Handler is allotted and module is initiated. After that, TBScriptletReadyState routine is executed. At this time, menu scriptlet is initiated and event handler is allotted.

Then Document.onReadyStateChange( ) routine is executed. At this time, event handler is allotted.

After Document.onReadyStateChange( ) is executed TBLayoutToolbars routine and TBlnitToolbar routine is executed.

Total menu layout is drawn up in TBLayoutToolbars routine, then TBLayoutBodyElement routine is executed. At this time, main body layout is drawn up and main body frame is loaded.

Also, TBToolbar is initiated in TBlnitToolbar routine. Then, TBPopulateToolbar routine is executed to draw up TBToolbar. Then, TBlnitButton routine is executed to make TBButton/TBState. TBlnitToolbarMenu routine is executed to make TBMenus. Then, TBBuildMenu routine is executed.

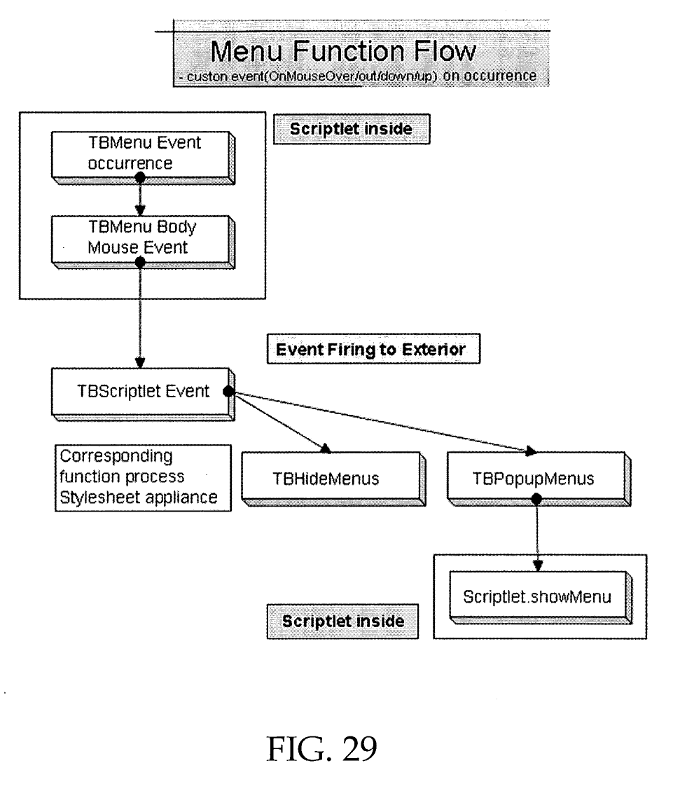

FIG. 29 is a flowchart illustrating call for subroutine that is relevant to menu bar component occurring when pointer move on Web desktop interface.

TBMenu event generation procedure is done in scriptlet. Then TBMenu Body Mouse Event routine is executed.

After that, Event Firing to exterior is done. First, TBScriptlet Event routine is done, then TBHideMenus and TBPopupMenus routine is executed to process the corresponding function and apply stylesheet. After TBPopupMenus routine, Scriptlet.showMenu routin is executed in scriptlet.

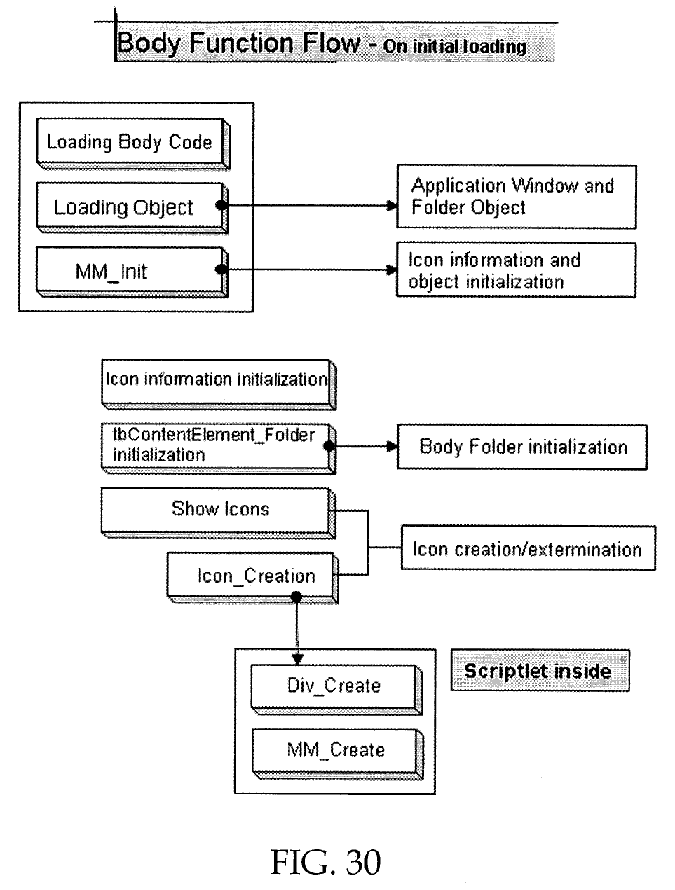

FIG. 30 is a flowchart illustrating subroutine call procedure relevant to main body element when Web desktop interface is loaded.

First, main body code is loaded and then object is loaded. At this time, application information and object initiation is executed. Icon information is initiated,

Then, tbContentElement_Folder initiation routine is executed. At this time, main body folder is initiated. Then Show Icon routine displaying icon is executed. Icon Creation routine (Icon_Creation) is following. Div_Create routine and MM_Create routine is executed in scriptlet.

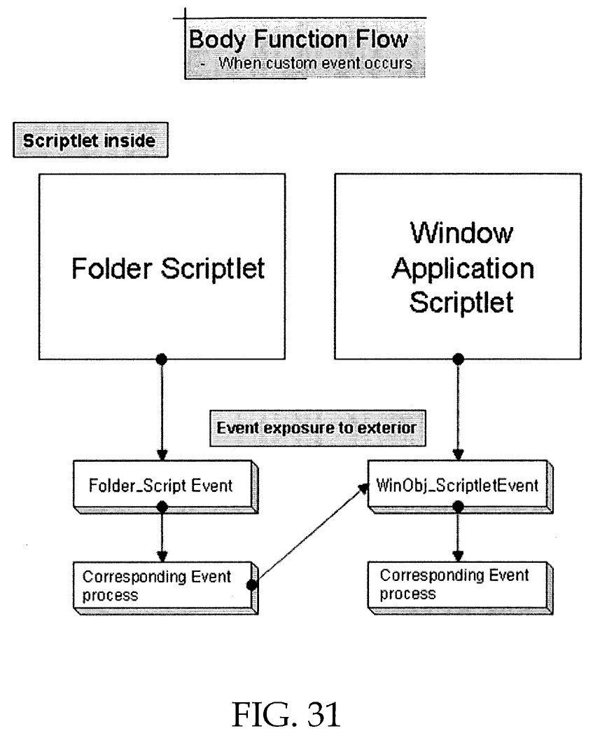

FIG. 31 is a flowchart illustrating subroutine call procedure relevant to main body element when predetermined action occurs on Web desktop interface. Folder scriptlet and application window scriptlet is executed in scriplet.

In folder scriptlet, Folder_Script Event routine is performed with exposing the event to exterior. Then corresponding event is processed. And WinObj_ScriptletEvent is as follows.

In application window scripltet, WinObj_ScriptletEvent routine is performed with exposing event to exterior. Then, the event is handled.

### INDUSTRIAL APPLICABILITY

Web desktop interface and Web desktop Operation System provide computer interface and Operating System based on Web on internet. Therefore, it is possible that user have uniform user interface and work environment under whatever hardware platform and Operating System providing Web.

In the claims:

1. An apparatus for providing interface based on Web on internet comprising,
main body folder means in fixed size,
menu bar means at which program execution link is located, and which is displayed at predetermined position,
lower object means formed on the main folder
icon means at which program execution link and URL link is located, which formed on the main body folder and
main frame means communicating with main folder means, menu bar means, lower object means, and icon means.

2. The apparatus of claim 1, wherein the lower object means includes folder object, first type application window, and second application window.

3. The apparatus of claim 1, wherein server module means is provided further, for transforming and data received from the main body frame according to Web protocol and transmitting it to server, and transmitting data received from the server to the main body frame.

4. The apparatus of claim 3, wherein the server module means is embodied as distributed data access service managing communication of distributive data with server.

5. The apparatus of claim 1, wherein the main folder means, the menu bar means, the lower object means, the icon means and the main frame means are Web based user interface formed on scriptlet.

6. An apparatus for supporting Web desktop architecture comprising,
means for managing cell layer(2401) defining cell for transmitting relevant with elements comprising user interface based on Web to server,
means for managing Web desktop protocol(WDP) layer(2403) including Web desktop service(WDS) layer(2405) and distributed data access service(DDAS) layer(2507) processing distributed data access and
means for managing client server protocol layer(2409).

7. The apparatus of claim 6, wherein the user interface based on Web comprise
main folder means in fixed size,
menu bar means at which program execution link is located, and displayed on specific position of main body folder,
icon means at which program execution link and URL link is located, and the main body folder mean and
main body frame communicating with the menu bar means, the lower object means, and the icon means.

8. A method of controlling the transmission on network to which server and client connect comprise,
creating data unit cell having the predetermined number to process the action occurred
judging whether data cell is a critical cell or a non critical cell,
storing the non critical cell to buffer in case of a non critical cell,
creating data unit by combining the non critical cell and non critical cell stored in buffer in case of a critical cell and
transmitting the created data unit to the server.

9. The method of claim 8, wherein the data unit cell include data field necessary for processing the action and action type field about the action type

10. The method of claim 8, wherein judging whether a Critical Cell or a Non Critical Cell comprise,
referring to action type field of the data cell and
judging as a critical cell that is critical on loss, otherwise as a non critical cell by referring lookup table recording cell list which are critical or not critical on loss according to action type of the data cell.

11. The method of claim 8, wherein judging whether a critical cell or non critical cell comprise,
referring the action type field of the data cell and
judging as a critical cell that need to be processed immediately, otherwise as a non critical cell by referring lookup table recording cell list which need to be processed immediately or does not, according to action type of the data cell.
